(19) United States
(12) Patent Application Publication
(10) Pub. No.: US 2014/0082422 A1
(43) Pub. Date: Mar. 20, 2014

(54) SYSTEM AND METHOD FOR DISPLAYING TEST STATES AND MARKING ABNORMALITIES

(71) Applicant: HON HAI PRECISION INDUSTRY CO., LTD., New Taipei (TW)

(72) Inventor: FENG-CHI YANG, New Taipei (TW)

(21) Appl. No.: 13/939,316

(22) Filed: Jul. 11, 2013

(30) Foreign Application Priority Data
Sep. 17, 2012 (CN) 2012103442669

(51) Int. Cl. G06F 11/07

(52) U.S. Cl. CPC G06F 11/079
USPC 714/37

(57) ABSTRACT

A method for an electronic device to manage test items of an object by displaying test states and marking abnormalities. The method captures an image of a state table of a finished test item displayed on a display screen of a testing device. The method further obtains a test result of the finished test item by comparing the captured image of the finished test item with a prestored standard table. When the test state of the finished test item is abnormal, the method records the captured image of the finished test item with a time index and outputs a failed message and the name of the finished test item with the time index.

### BACKGROUND

1. Technical Field

Embodiments of the present disclosure relate to test management technology, and particularly to a system and a method for displaying test states and marking abnormalities to manage test items of an object.

2. Description of Related Art

During a testing procedure, if test items of an unit under test (UUT) (e.g. an object) fail, a detailed report needs to be provided regarding the failures according to a system event log (SEL) and manual observation of the whole testing procedure. However, if one test item takes a long time (e.g. one or more days), it is difficult to monitor the whole testing procedure due to the length of time. Furthermore, when a test item fails, the failure can only be analyzed by looking at the SEL, without graphical data of the testing procedure. An Internet Protocol (IP) camera or a charge-coupled device (CCD) can be used to record test information. However, review all of the recorded test information to find out the reasons for failure is inefficient and inconvenient.

### BRIEF DESCRIPTION OF THE DRAWINGS

FIG. 1 is a schematic diagram of one embodiment of an electronic device including a management system.

FIG. 2 is a block diagram of one embodiment of function modules of the management system in the electronic device in FIG. 1.

FIG. 3A and FIG. 3B are schematic diagrams illustrating one embodiment of a state image.

FIG. 4 is a flowchart illustrating one embodiment of a method to manage test items of an object by displaying test states and marking abnormalities.

### DETAILED DESCRIPTION

The disclosure, including the accompanying drawings, is illustrated by way of examples and not by way of limitation. It should be noted that references to “an” or “one” embodiment in this disclosure are not necessarily to the same embodiment, and such references mean “at least one.”

In general, the word “module,” as used herein, refers to logic embodied in hardware or firmware unit, or to a collection of software instructions, written in a programming language. One or more software instructions in the modules may be embedded in firmware unit, such as in an EPROM. The modules described herein may be implemented as either software and/or hardware modules and may be stored in any type of non-transitory computer-readable medium or other storage device. Some non-limiting examples of non-transitory computer-readable media may include CDs, DVDs, BLU-RAY, flash memory, and hard disk drives.

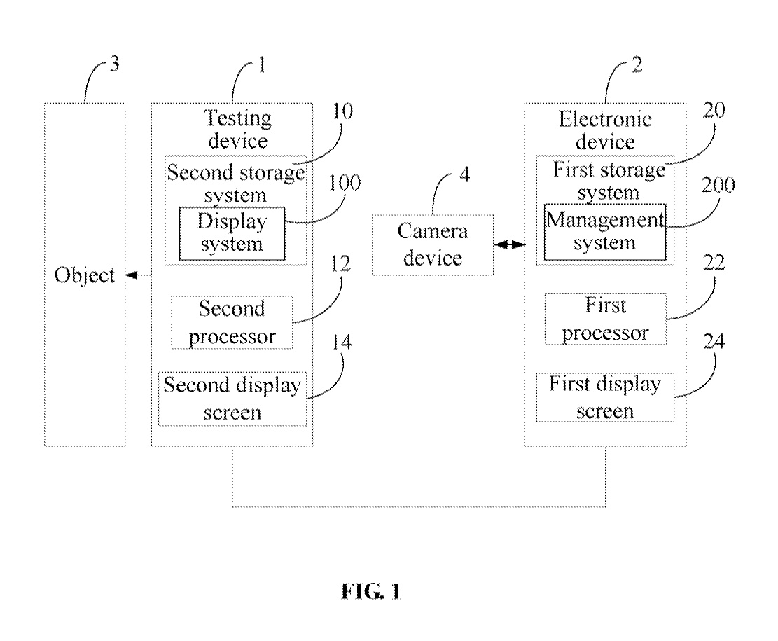

FIG. 1 is a schematic diagram of one embodiment of an electronic device 2 including a management system 200. The electronic device 2 further includes a first storage system 20, a first processor 22, and a first display screen 24. The electronic device 2 is connected to a testing device 1. The testing device 1 performs test items on an object 3 and monitors test states of the test items. The testing device 1 includes a second storage system 10, a second processor 12, and a second display screen 14. The testing device 1 further includes a display system 100, which comprises computerized codes in the form of one or more programs stored in the second storage system 10. The electronic device 2 is further connected to a camera device 4, and controls the camera device 4 to capture images displayed on the second display screen 14. The camera device 4 also may be installed on the electronic device 2.

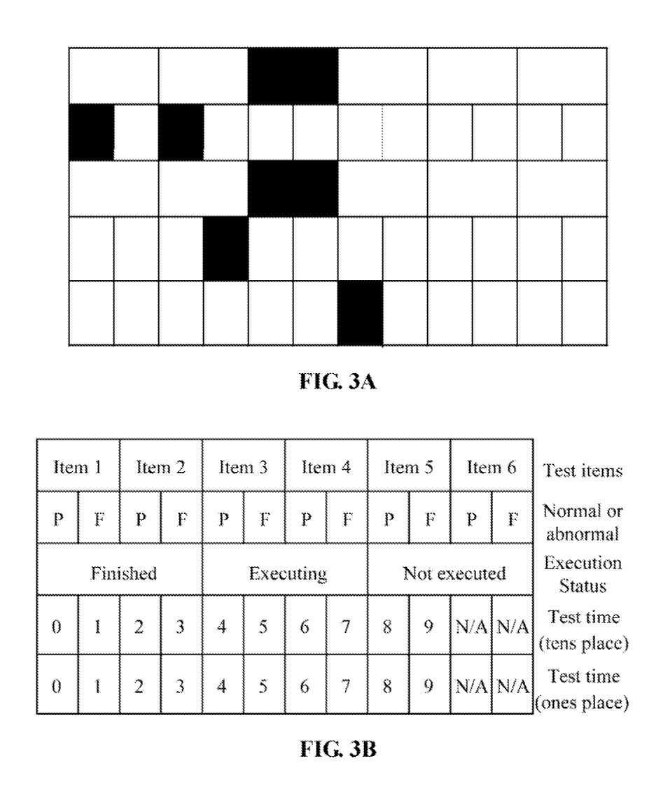

The display system 100 receives test parameters and table parameters from the second display screen 14. The test parameters include a plurality of predetermined test items for testing the object 3. The test items may be a test of life analysis and a test of materials identification of hardware, for example. The table parameters include configurations of a state table. The testing device 1 tests the object 3 according to the test items. Once one test item is finished testing, the display system 100 obtains test states of the finished test item, and marks the test states in the state table on the second display screen 14 according to the table parameters. An example of the state table is shown in FIG. 3A. An arrangement of the state table may be configured or changed according to actual requirements. The management system 200 displays test states of failed test items using images of the test states on a the first display screen 24.

The first storage system 20 may be a memory (e.g., random access memory, flash memory, hard disk drive) of the electronic device 2. The first processor 22 executes one or more computerized codes and other applications of the electronic device 2 to provide functions of the management system 200.

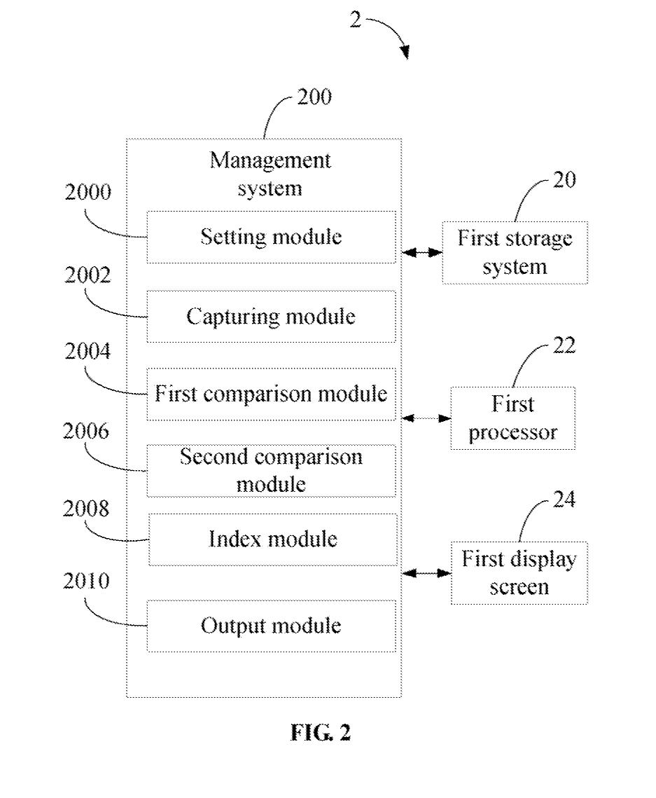

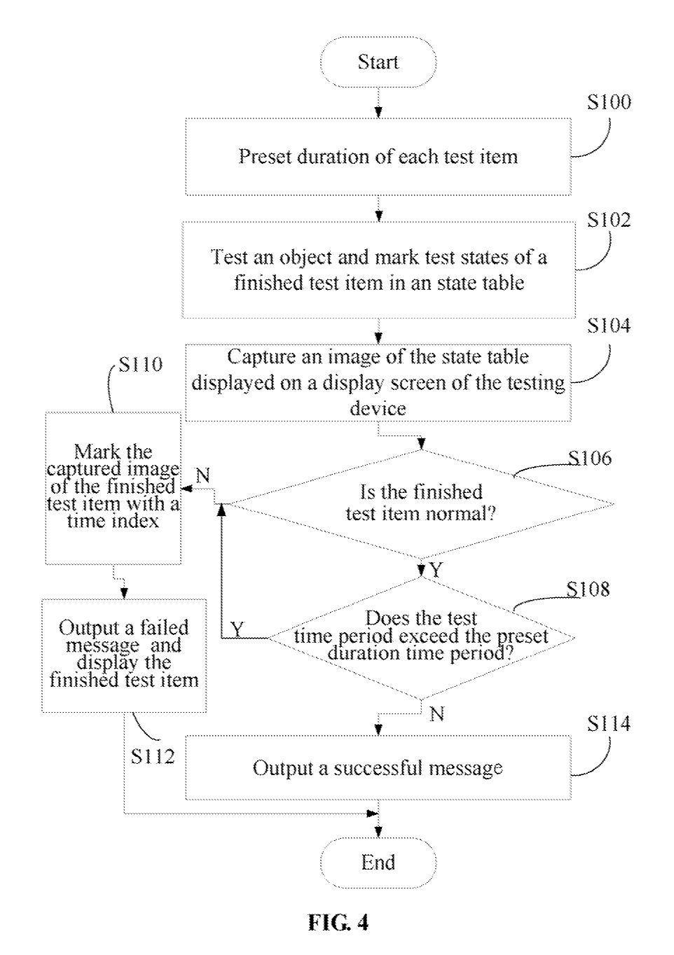

FIG. 2 is a block diagram of one embodiment of function modules of the management system 200 in the electronic device 2. The management system 200 includes a setting module 2000, a capturing module 2002, a first comparison module 2004, a second comparison module 2006, an index module 2008, and an output module 2010. The modules 2000, 2002, 2004, 2006, 2008, and 2010 comprise computerized codes in the form of one or more programs that are stored in the first storage system 20. The computerized codes include instructions that are executed by the first processor 22 to provide functions for the modules. Details of each of the modules are given in FIG. 4.

FIG. 4 is a flowchart illustrating one embodiment of a method to manage test items of an object by displaying test states and marking abnormalities. Depending on the embodiment, additional steps may be added, others deleted, and the ordering of the steps may be changed.

In step S100, the setting module 2000 presets a duration for each test item. The preset duration may be different for the test items. The preset duration is a threshold value for determining whether a test time period of each test item is too long.

In step S102, when a procedure of testing a test item of the object 3 is finished, the display system 100 marks test states of the finished test item in the state table on the display screen 14. The state table includes a plurality of cells. The test states of the finished test item include a test result of the finished test item and a test duration of the finished test item. In one embodiment, the display system 100 further marks test states of previous finished test items and a test item that has started testing. The display system 100 marks the test states by marking the cells in the state table a preset color or a preset icon. Each cell of the state table represents a corresponding information.

As shown in FIG. 3B, the first row represents a name of each test item (e.g.

“Item 1”, “Item 2” . . . and “Item 6” shown in FIG. 3B), and the second row represents a test result of each test item that has finished executing. The test result may be a pass (represented as “P”) or fail (represented as “F”). If the test result is a pass, the test item is normal. If the test result is a fail, the test item is abnormal. The third line represents an execution state of each test item. The execution state may be finished, executing, or pending execution. The fourth line and the fifth line represent a test duration of a finished test item. The fourth line represents a tens place of the test duration, while the fifth line represents a ones place of the test duration.

According to the above-mentioned representations, if the display system 100 marks cells in the state table as shown in FIG. 3A, it is represented that a test item named “Item 2” has just finished testing, a test result of the “Item 2” being a pass, and a test duration of the “Item 2” being equal to 36 seconds. Furthermore, according to FIG. 3A, a test result of a previous finished test item named “Item 1” is a pass, and a test item named “Item 3” after the “Item 2” has started executing.

In step S104, the capturing module 2002 captures an image of the state table of the finished test item. The captured image is stored in the first storage system 20.

In step S106, when the image of the finished test item is captured, the first comparison module 2004 obtains a test result of the finished test item by comparing the captured image with a prestored standard table, and determines whether or not the test state of the finished test item is normal according to the obtained test result. If the test result of the finished test item is passed, the test state of the finished test item is determined to be normal, and step S108 is implemented. If the test result of the finished test item is failed, the test state of the finished test item is determined to be abnormal, and step S110 is implemented.

In one embodiment, the prestored standard table has the same layout and the same size of cells as the state table in the captured image, but none of the cells in the prestored standard table have been marked. Information represented by each cell of the prestored standard table is the same as the information represented by the state table. Therefore, according to different parts (e.g. marked cells) between the captured image of the state table and the prestored standard table, the information represented by the different parts (e.g. test result and test duration) can be determined

In step S108, the second comparison module 2006 obtains the test duration of the finished test item by comparing the captured image with the prestored standard table, and determines whether or not the test duration exceeds the preset duration of the finished test item. If the test duration exceeds the preset duration of the finished test item, step S110 is implemented. If the test duration does not exceed the preset duration of the finished test item, step S114 is implemented.

In step S110, the index module 2008 records the captured image of the finished test item with a time index. The time index can be obtained according to a system time of the electronic device 2.

In step S112, the output module 2010 outputs a failed message of the finished test item and outputs the name of the finished test item with the time index on the first display screen 24.

In step S114, the output module 2010 outputs a successful message of the finished test item on the first display screen 24.

All of the processes described above may be embodied in, and be fully automated via, functional code modules executed by one or more general-purpose processors. The code modules may be stored in any type of non-transitory computer-readable medium or other storage device. Some or all of the methods may alternatively be embodied in specialized hardware. Depending on the embodiment, the non-transitory computer-readable medium may be a hard disk drive, a compact disc, a digital video disc, a tape drive or other suitable storage medium.

The described embodiments are merely possible examples of implementations, set forth for a clear understanding of the principles of the present disclosure. Many variations and modifications may be made without departing substantially from the spirit and principles of the present disclosure. All such modifications and variations are intended to be included herein within the scope of this disclosure and the described inventive embodiments, and the present disclosure is protected by the following claims.

What is claimed is:

1. A computer-implemented method for managing test items of an object using an electronic device, the electronic device being in communication with a testing device that monitors test states of the test items of the object, the method comprising:
capturing an image of a state table of a finished test item displayed on a display screen of the testing device;
obtaining a test result of the finished test item by comparing the captured image of the finished test item with a prestored standard table, and determining whether a test state of the finished test item is normal according to the obtained test result;
recording the captured image of the state table and the finished test item with a time index, outputting a failed message of the finished test item and outputting a name of the finished test item with the time index, when the test state of the finished test item is abnormal.

2. The method as described in claim 1, further comprising:
obtaining a test duration of the finished test item and determining whether the test duration exceeds a preset duration of the finished test item, when the test state of the finished test item is normal; and
recording the captured image and the finished test item with the time index, outputting the failed message and outputting the name of the finished test item with the time index, when the test duration exceeds the preset duration of the finished test item; or
outputting a successful message of the finished test item, when the test duration does not exceed the preset duration of the finished test item.

3. The method as described in claim 1, wherein the testing device tests the object according to predetermined test items, and marks test states of the finished test item in the state table, the test states of the finished test item comprising the test result of the finished test item and the test duration of the finished test item.

4. The method as described in claim 3, wherein the prestored standard table is the same as the captured image of the state table but without marking any test state.

5. The method as described in claim 1, further comprising:
determining that the test state of the finished test item is normal when the test result is passed; or
determining that the test state of the test item is abnormal when the test result is failed.

6. The method as described in claim 1, wherein the captured image is captured by a camera device of the electronic device.

7. An electronic device for managing test items of an object, the electronic device in communication with a testing device that monitors test states of the test items of the object, the electronic device comprising:
at least one processor; and
a computer-readable storage medium storing one or more programs, which when executed by the at least one processor, the one or more programs comprising causes the at least one processor to:
capture an image of a state table of a finished test item displayed on a display screen of the testing device;
obtain a test result of the finished test item by comparing the captured image of the finished test item with a prestored standard table, and determine whether the test state of the finished test item is normal according to the obtained test result;
mark the captured image of the state table and the finished test item with a time index and output a failed message of the finished test item and outputs a name of the finished test item with the time index, when the test state of the finished test item is abnormal.

8. The electronic device as described in claim 7, wherein the one or more programs further comprising causes the at least one processor to:
obtain a test duration of the finished test item and determine whether the test duration exceeds a preset duration of the finished test item, when the test state of the finished test item is normal; and
mark the captured image and the finished test item with a time index, output the failed message and outputs the name of the finished test item with the time index, when the test duration exceeds the preset duration of the finished test item; and
output a successful message of the finished test item, when the test duration does not exceed the preset duration of the finished test item.

9. The electronic device as described in claim 7, wherein the testing device tests the object according to test items of testing the object, and displays test states of the finished test item in the state table, the test states of the finished test item comprising the test result of the finished test item and the test duration of the finished test item.

10. The electronic device as described in claim 9, wherein the prestored standard table is the same as the captured image of the state table but without marking any test state.

11. The electronic device as described in claim 7, wherein the one or more programs further comprising causes the at least one processor to:
determining that the test state of the finished test item is normal when the test result is passed; or
determining that the test state of the test item is abnormal when the test result is failed.

12. The electronic device as described in claim 7, wherein the captured image is captured by a camera device of the electronic device.

13. A non-transitory computer readable storage medium having stored thereon instructions that, when executed by a processor of an electronic device, causes the electronic device to perform a method for managing test items of an object in an electronic device, the electronic device being in communication with a testing device that monitors test states of the test items of the object, the method comprising:
capturing an image of a state table of a finished test item displayed on a display screen of the testing device;
obtaining a test result of the finished test item by comparing the captured image of the finished test item with a prestored standard table, and determining whether the test state of the finished test item is normal according to the obtained test result;
recording the captured image of the state table and the finished test item with a time index, outputting a failed message of the finished test item and outputting a name of the finished test item with the time index, when the test state of the finished test item is abnormal.

14. The non-transitory computer readable storage medium as described in claim 13, further comprising:
obtaining a test duration of the finished test item and determining whether the test duration exceeds a preset duration of the finished test item, when the test state of the finished test item is normal; and
recording the captured image and the finished test item with a time index, outputting the failed message and outputting a name of the finished test item with the time index, when the test duration exceeds the preset duration of the finished test item; or
outputting a successful message of the finished test item, when the test duration does not exceed the preset duration of the finished test item.

15. The non-transitory computer readable storage medium as described in claim 14, wherein the testing device tests the object according to test items of testing the object, and displays test states of the finished test item in the state table, the test states of the finished test item comprising the test result of the finished test item and the test duration of the finished test item.

16. The non-transitory computer readable storage medium as described in claim 15, wherein the prestored standard table is the same as the captured image of the state table but without marking any test state.

17. The non-transitory computer readable storage medium as described in claim 13, further comprising:
determining that the test state of the finished test item is normal when the test result is passed; or
determining that the test state of the test item is abnormal when the test result is failed.

18. The non-transitory computer readable storage medium as described in claim 13, wherein the captured image is captured by a camera device of the electronic device.
